(19) United States
(12) Patent Application Publication
(10) Pub. No.: US 2008/0047311 A1
(43) Pub. Date: Feb. 28, 2008

(54) KEY HEAD COVER

(75) Inventors: H. Douglas McKinnon, Edmonton (CA); Edward C. Henshall, Edmonton (CA); Gordon G. McKinnon, Edmonton (CA)

Correspondence Address: DAVIS BUJOLD & Daniels, P.L.L.C., 112 PLEASANT STREET, CONCORD, NH, 03301, US

(73) Assignee: The ID Key Company Inc., Edmonton (CA)

(21) Appl. No.: 11/852,553

(22) Filed: Sep. 10, 2007

(30) Foreign Application Priority Data
Aug. 25, 2006 (CA) 2,557,991

(51) Int. Cl. E05B 19/04

(52) U.S. Cl. 70/408

(57) ABSTRACT

A key head cover includes a body adapted to cover an upper portion of a key. The body has a first face, a second face, and an inner cavity for retaining the upper portion of the key. A recess is provided in at least one of the first face or the second face for receiving an insert. The recess has a peripheral edge. The recess is adapted to receive an insert having a peripheral edge, such that the peripheral edge of the insert is immediately adjacent to the peripheral edge of the recess.

### FIELD

The present application relates to a key head cover for a key used to open a lock, such as a car door lock or an entry door lock.

### BACKGROUND

When an automobile is sold by a car dealership, a decal with the name of the car dealership is placed on keys for the automobile. The decal is usually secured to the front of each key with adhesive. Problems are being experienced with keeping the decal secured. The decal eventually falls off the key. U.S. Pat. No. 6,094,954 (Carmen) identifies a key assembly with a slot and insert, that could be used as an alternative approach to placing the name of the car dealership on keys.

### SUMMARY

There is provided a key head cover which includes a body adapted to cover an upper portion of a key. The body has a first face, a second face, and an inner cavity for retaining the upper portion of the key. A recess is provided in at least one of the first face or the second face for receiving an insert. The recess has a peripheral edge. The recess is adapted to receive an insert having a peripheral edge, such that the peripheral edge of the insert is immediately adjacent to the peripheral edge of the recess.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a partially transparent front elevation view of a key head cover.

FIG. 2 is a rear elevation view of the key head cover of FIG. 1.

FIG. 3 is a side plan view in section of the key head cover of FIG. 1.

FIG. 4 is an exploded side plan view in section of a variation of the key head cover shown in FIG. 1.

### DETAILED DESCRIPTION

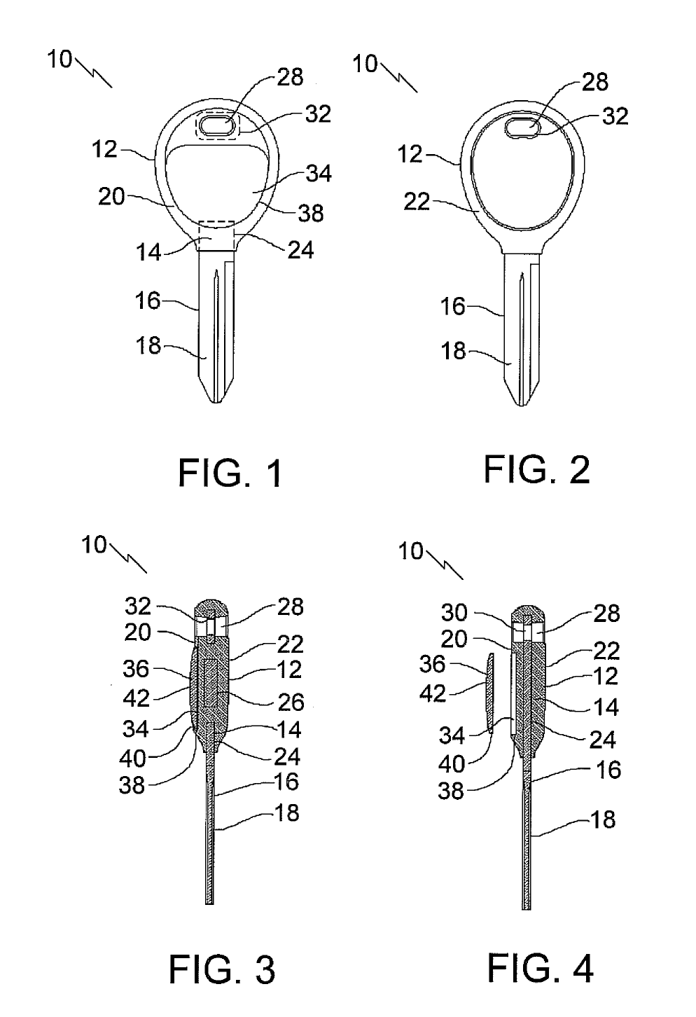

A key head cover generally identified by reference numeral 10, will now be described with reference to FIGS. 1 through 4.

Structure and Relationship of Parts:

Referring to FIG. 1, key head cover 10 is shown having a body 12 molded onto the upper portion 14 of a key 16, which also has a shaft 18 that acts as the keyed portion. It will be understood that shaft 18 may take various shapes and sizes, according to the types of keys and keyholes known in the art. Referring to FIG. 3, body 12 has a first face 20, a second face 22, and an inner cavity 24. Inner cavity 24 retains upper portion 14 of key 16. Referring to FIG. 4, it will be understood that upper portion 14 of key 16 may be a key head. However, as shown in FIG. 3, it may also be smaller than the usual key head, such that body 12 can also accommodate a transmitter 26, if desired. Referring to FIG. 4, if upper portion 14 is a key head, the key ring opening 28 of body 12 aligns with key ring opening 30 of key 16. Otherwise, referring to FIG. 1, a metal insert 32 may be used to provide structural support to opening 28, and to give the impression that upper portion 14 is a key head, as can be seen in FIG. 2.

Referring to FIG. 4, there is a recess 34 in first face 20 for receiving a display insert 36. Recess 34 has a peripheral edge 38. Recess 34 is adapted to receive insert 36, which also has a peripheral edge 40, such that peripheral edge 40 of insert 36 is immediately adjacent to peripheral edge 38 of recess 34. Display insert 36 is then secured in recess 34 with adhesive.

Display insert 36 has a display face 42 which may display such things as a trademark, a product name, a business name, or a logo. For example, a car dealer may have key blanks with a specialized display insert 36 displaying the dealership's name and logo, as well as the make of the car shown in display face 38 to distribute with a newly sold car. Display face 38 may also serve other functions. For example, it may be made from non-slip material, such as acrylic, and a portion of it may extend outward beyond recess 34, such that key 16 becomes easier to handle. However, it is preferred that peripheral edge 40 of insert 36 is flush or slightly below peripheral edge 38 of recess 34, such that insert 36 is sheltered from being picked at, snagging on objects, or other lateral forces being directly applied to insert 36. This helps ensure that insert 36 will not be easily removed. In addition body 12 may be given a textured surface to improve grip, such as a fine stipple grain pattern.

Operation:

Referring to FIG. 1, key head cover 10 is formed by molding body 12, which is preferably a polyester, plastic, resin, or other suitable material, onto upper portion 14 of key 16. Referring to FIG. 3, transmitter 26 and metal insert 32 may be included within body 12 during molding, if desired. Body 12 is molded such that a recess 34 with a peripheral edge 38 is formed. A customized display insert 36 may then be inserted into recess 34 with display face 42 facing outward, and with peripheral edge 40 of display insert 36 immediately adjacent peripheral edge 38 of recess 34. By having peripheral edges 38 and 40 immediately adjacent, it becomes less likely that insert 36 will become detached from key head 10 during the normal course of its use. Adhesive is used to ensure a more secure hold on insert 36.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope defined in the Claims.

What is claimed is:

1. A key head cover, comprising:
a body adapted to cover an upper portion of a key, the body having a first face, a second face, and an inner cavity for retaining the upper portion of the key; and
a recess in at least one of the first face or the second face for receiving an insert, the recess having a peripheral edge, where the recess is adapted to receive an insert having a peripheral edge, such that the peripheral edge of the insert is immediately adjacent to the peripheral edge of the recess.

2. The key head cover of claim 1, wherein the insert is retained in the recess with adhesive.

3. The key head cover of claim 1, wherein the insert has a display face facing outward when inserted into the recess.

4. The key head cover of claim 3, wherein at least a portion of the display face protrudes outward beyond the recess.

5. The key head cover of claim 3, wherein the display face of the insert has a non-slip covering.

6. The key head cover of claim 3, wherein the display face displays one of a business name, a brand name, or a logo.

7. The key head cover of claim 1, wherein the body has a key ring opening.

8. The key head cover of claim 1, wherein the upper portion of the key is a key head, and the body covers the key head.

9. In combination:
a key having an upper portion and a shaft;
a display insert having a display face; and
a key head cover, comprising:
a body molded onto the upper portion of the key, the body having a first face, a second face, and an inner cavity retaining the upper portion of the key; and
a recess in at least one of the first face or the second face for receiving the display insert, the recess having a peripheral edge, where the recess is adapted to receive an insert having a peripheral edge, such that the peripheral edge of the insert is immediately adjacent to the peripheral edge of the recess, the display insert being secured in the recess with adhesive;

10. The combination of claim 9, wherein the display face comprises non-slip material.

11. The combination of claim 9, wherein at least a portion of the display face protrudes outward beyond the recess.

12. The combination of claim 9, wherein the display face displays one of a business name, a brand name, or a logo.

13. A key head cover, comprising:
a body adapted to cover an upper portion of a key, the body having a first face, a second face, and an inner cavity for retaining the upper portion of the key; and
a recess in at least one of the first face or the second face for receiving an insert, the recess having a peripheral edge; and
an insert having a peripheral edge, the recess adapted to receive the insert such that the peripheral edge of the insert is immediately adjacent to the peripheral edge of the recess.
